(19) United States
(12) Patent Application Publication
(10) Pub. No.: US 2010/0227088 A1
(43) Pub. Date: Sep. 9, 2010

(54) Method for Producing Paper or Plastic Container of Heat Insulation, Heat Preservation and Scald Prevention and the Same Container Obtained Thereby

(76) Inventor: Sheng-Shu CHANG, Taichung, Taiwan (CN)

Correspondence Address: TROXELL LAW OFFICE PLLC, 5205 LEESBURG PIKE, SUITE 1404, FALLS CHURCH, VA, 22041, US

(21) Appl. No.: 12/160,383

(22) PCT Filed: Dec. 13, 2006
(86) PCT No.: PCT/CN06/03389

§ 371 Date: Jul. 9, 2008

(30) Foreign Application Priority Data
Jan. 10, 2006 (CN) 200610000640.8

(51) Int. Cl. B32B 1/02

(52) U.S. Cl. 428/34.2; 428/35.7; 264/134

(57) ABSTRACT

A method for producing paper or plastic container of heat insulation, heat preservation and scald prevention and the same container obtained thereby are disclosed. The method includes the following steps: agitating and mixing (3) a liquid binder with a heat-resistant foamed particle powder (2) to prepare a composite coating (4); applying the composite coating (4) onto a given area of a continuous paper strip (p), a plastics or a plastic container (7,7′), and heating it and then making the heated continuous paper strip (p) or the plastics into a required shaped container according to the prior art. The properties of the inventive container include heat insulation, heat preservation and scald prevention and so on, so when the container contains a substance of higher temperature, a user's hand would not be scalded even if the user holds the container. The inventive method is applicable to prepare various paper or plastic containers, such as cups, bowls, dishes, fast food boxes and various packing containers. The obtained containers are of heat insulation, heat preservation and scald prevention.

### BACKGROUND OF THE INVENTION

1. Field of the Invention

This invention relates to a process of manufacturing a paper-made or plastics-made container and particularly to a process of manufacturing a heat insulation, heat preservation, and scald-proof paper-made or plastics-made container provided with a pattern, and product for the same, serving as a daily-life appliance for use.

2. Description of Related Art

A conventional container, in consideration of a cost and a purpose, is generally a paper-made or plastics-made container, such as a paper-made or plastics-made cup, bowl, and dish, or a filling container made of this material, such as a packaging container, a heat preservation container, and a lunch box. An existing paper-made container is provided in a single layer that cannot preserve and insulate heat. If being provided in two layers for a fold or a partition, the container is used only one time thereby its cost being extremely high and the cost efficiency being not satistied. If being provided in a single layer, the plastics-made container cannot preserve and insulate heat. Besides, being pleasing to the eye, only a surface layer of the existing paper-made or plastics-made container is at most printed, and the effect of 3D pattern is not achieved.

In consideration of heatproof condition, the existing paper-made cup is held with a plastic supporting cup, but it is inconvenient to add the supporting cup; after being used and discarded, the supporting cup must be preserved, indicating that the convenience of paper-made cup in use is reduced.

If the paper-made container or a semi-finished paper-made product is foamed, for example, as disclosed in U.S. Pat. No. 5,952,068, an acrylic gum is used, while it is foamed, for example, as disclosed in U.S. Pat. No. 6,265,040, in a temperature of 65˜100° C. The acrylic gum is in a high glass transition point, so a rate of foaming in a lower temperature is easily insufficient; in a higher temperature, the container is deformed and a extrusion laminating (PE or pp) of the paper-made cup is damaged. If the acrylic gum in a low glass transition point is used, it is easily adhesive in a normal temperature; for example, when a semi-finished product overlaps for storage, it is difficult to foam the product, thereby reserves being out of control. The acrylic gum that is softened in a certain temperature of heating, which is used as a base material generally in a process of cutting crystals or manufacturing electronic parts, is expensive so that it is not suitable in a cheap paper-made product for a one-time use.

Regarding the foaming base material that may foam in 65 through 100° C., it takes very much time the material provided in the paper-made product to fully foam, during which the paper-made container is made to be deformed, damaged, and re-mixed, making the production efficiency very low.

Consequently, because of the technical defects of described above, the applicant keeps on carving unflaggingly through wholehearted experience and research to develop the present invention, which can effectively improve the defects described above.

### SUMMARY OF THE INVENTION

In order to solve technical issues mentioned above, this invention provides a new process of manufacturing a paper-made or plastics-made container, and thus in the process, the paper-made or plastics-made container is given for the effects of heat insulation, heat preservation, and scald proof. A colorful 3D pattern may be formed on an outside surface of the container and, in comparison of a plain paper-made or plastics-made container with the container according to this invention, is very pleasing to the eye. The technical issues mentioned above are solved in this invention by means of technical manners described below.

The process of manufacturing the heat insulation, heat preservation, and scald-proof paper-made or plastics-made container comprises the following steps of:
1. stirring and mixing a liquid adhesive with a heat-resistant foaming powder particles to form a compound coating); and
2. coating a compound coating in a predetermined area of a continuous paper roll or plastics or a predetermined area of a surface of a formed paper-made or plastics-made container, in which for the effects of heat insulation, heat preservation, and scald proof, the compound coating is coated in only a position and area of the formed container that may be gripped, namely, a predetermined area which may be controlled by those who skill in the art depending on a specific condition and an experience of practice; further heating the paper roll, plastics, or formed container (preferably in a temperature of 100 through 140° C.). to foam the surface by using foaming powder particles (in a volume, of up to 20-50 in which the liquid adhesive adheres to a surface layer of the container to make the surface layer of paper roll, plastics, or formed container adhesive onto the foaming layer, and then the continuous paper roll or the plastics is formed into the required container in the existing art.

In the manufacturing process, the liquid adhesive may be a water mixed liquid with a polyvinyl acetate resin or a polyethylene (PE)—polyvinyl acetate resist or both in a random ratio for an effect of solidification and adhesion in the process of heating and foaming. The liquid adhesive is available in a market.

The heat-resistant foaming powder particles is a thermoplastic polymer wrapping a low-boiling point solvent, which may finish in foaming in a shortest time and does not damage the paper-made produce. The heat-resistant foaming powder particles are available in the market.

Preferably, the liquid adhesive is mixed with the heat-resistant foaming powder particles in a weight ratio of 5-20:80-95.

In order to be pleasing to the eye, the paper-made or plastics-made container according to this invention is coated or rolled with the compound coating to which a colorful pigment may be added, so that the coating coated on a portion of pattern may foam after being heated and then a colorful protruding 3D pattern is formed, or a color printing is applied after the pattern is formed for diverse effects of artistic vision, in which an addition of color or a ratio of mixing of the colorful pigment with the compound coating may be controlled by those who skill in the art depending on a specific condition or an effective demand, and further the 3D pattern may bring the function of heat insulation at the time of grip, thereby multiple effects of artistic vision, heat preservation, heat insulation, and scald proof being achieved.

On the surface of various paper-made or plastics-made containers according to this invention, various 3D patterns are formed depending on pattern plates for achievement of the effects of artistic vision and scald proof at the time of grip on the portion of protruding pattern.

A degree of protrusion of the 3D pattern may be required in a thickness of the coated compound coating and a controlled temperature of 100 through 140° C. during heating, and the foaming may be done in a short time.

In the manufacturing process of this invention, a predetermined region of the surface layer outside the container when being formed is recessed, as shown in FIG. 4-C and then the compound coating is coated in the recessed area, in which in order to achieve the effects of heat insulation, heat preservation, and scald proof, the compound coating is coated in only the position and area of the formed container that may be gripped, namely, the predetermined area, which may be controlled by those who skill in the art depending on the specific condition; thus, after being heated and foaming, the compound coating is made to fill and level up the recessed position, which makes the surface layer outside the container recover the neat condition for the scald-proof effect brought to the position of grip, and for the cost-down request.

In this invention, after the liquid adhesive is mixed with the foaming powder particles in the ratio, fast foaming is achieved and no damage to the paper-made container and its inner film occurs by using the properties of materials in the manufacturing process of heating and foaming. By means of the surface layer of the container that is provided with the enhanced effect, s/he who grip the container filled with a very hot substance does not feel hot, thereby the effects of heat preservation, heat insulation, and scald proof being achieved.

The process of this invention may adapt for the manufacturing various paper-made or plastics-made container, such as the cup, the bowl, the dish, the lunch box, and various packaged container, all of which may provide the effects of heat insulation, heat preservation, and scald proof.

### BRIEF DESCRIPTION OF THE DRAWINGS

FIG. 1 is a schematic view illustrating a manufacturing process of this invention;

FIG. 2 is a schematic view illustrating a roller device according to this invention;

FIG. 2A is a schematic plan view illustrating a coated semi-finished paper-made container according to this invention;

FIG. 2B is a view of embodiments of the finished paper-made container before and after coated according to this invention;

FIG. 2C is a view of an embodiment of a surface layer coated with a pattern according to this invention;

FIG. 3A is a view of an embodiment of the paper-made container according to this invention of which the surface layer is foamed;

FIG. 3B is a view of an embodiment of the paper-made container according to this invention of which the pattern on the surface layer is foamed;

FIG. 3C is a view of another embodiment of the paper-made container according to this invention of which the surface layer is foamed;

FIG. 4A is a view of a condition indicating that a fully foamed layer is formed on the surface layer of the paper-made container according to this invention;

FIG. 4B is a view of a condition indicating that a partially foamed layer is formed on the surface layer of the paper-made container according to this invention; and

FIG. 4C is a view of a condition indicating that a padded foamed layer is formed on a recessed surface layer the paper-made container according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

In order to let you further know the features and technical means of this invention, refer to the following detailed description according to this invention accompanied with drawings; however, the accompanied drawings are provided for reference and illustration only and are not limited to this invention.

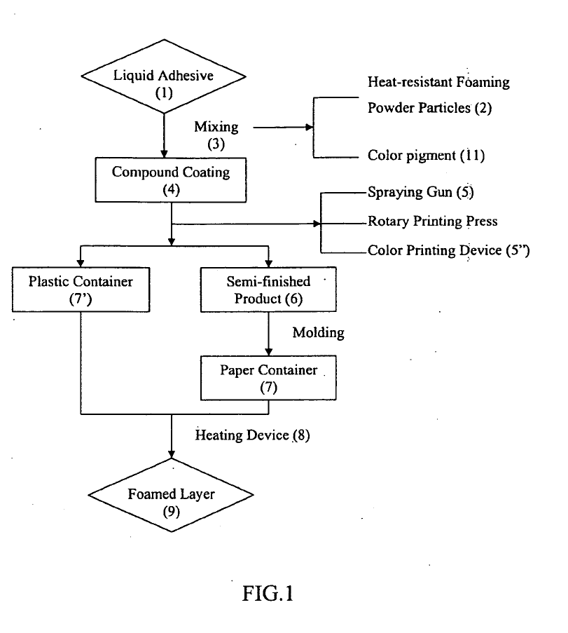

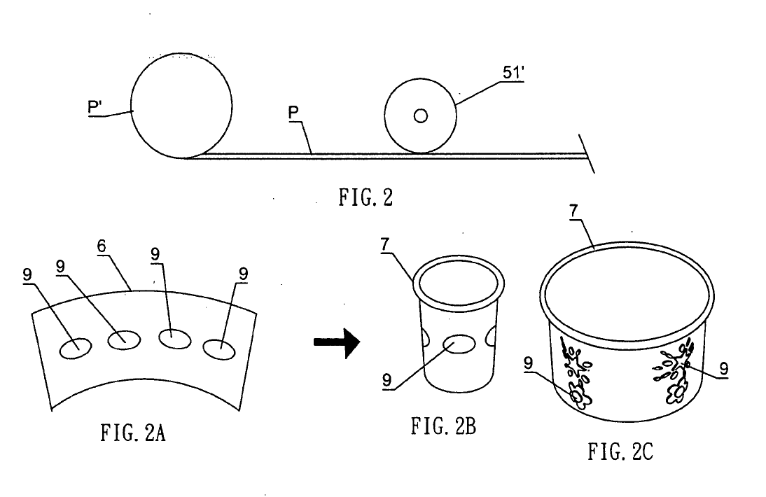

With reference to FIG. 1, in a manufacturing process of this invention, heat-resistant foaming powder particles 2 are added to a liquid adhesive 1, and by means of mixing 3, a compound coating 4 is formed; in a manner of coating, comprising at least a spraying gun 5, a roller 5′, and a color printing device 5″, the compound coating 4 is coated on a semi-finished product 6, as shown in FIG. 2-A, and then a container 7 is formed or the coating 4 is directly coated on a surface of a finished paper-made container 7, as shown in FIGS. 2B-C and 3A-C. A heating device 8 is used to heat the container 7 and 7′ to foam the surface layer by using the heat-resistant foaming powder particles 2. The liquid adhesive 1 adhere to the surface layer of the container 7 and 7′ to form a foamed layer 9 on the surface layer for an enhanced effect and effects of heat insulation and heat preservation.

The liquid adhesive 1 may be a water mixed liquid with a polyvinyl acetate resin or a polyethylene (PE)—polyvinyl acetate resin or both for an effect of solidification and for objects of storage and use at any time, the adhesive 1 being not adhesive in a normal temperature.

The heat-resistant foaming powder particle 2 is a thermoplastic polymer wrapping a low-boiling point solvent.

The liquid adhesive 1 is mixed with the heat-resistant foaming powder particles 2 in a weight ratio of 5%˜20%, which foams in a volume of more than 4 times as a degree.

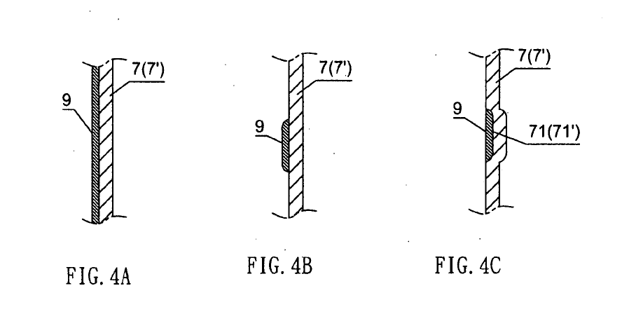

With reference to FIGS. 1 and 2, the compound coating 4 may directly a pattern model on a roller 51′ of a rotary printing press 5′. The roller 51′ of the rotary printing press 5′ is used to print the pattern model with the compound coating 4 and continuously roll on the continuous paper roll P of the cartridge paper roll P′, then a semi-finished product 6 is cut for the predetermined container 7, as shown figure 2-A, and after the container is formed (not featured in this invention and thus omitted), the container 7 (7′) is heated and thus a foamed layer 9 is formed on the surface layer outside the container, as shown in FIG. 4-A.

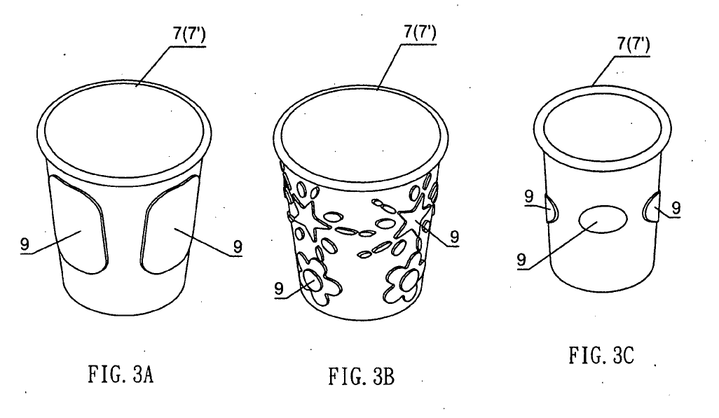

With reference to FIGS. 1, 2, and 4, in the manner mentioned above, the surface layer of the paper-made container 7 and 7′ may be used for the effect of heat insulation, thereby s/he who grip the container filled with a very hot substance not feeling hot and the effects of heat preservation, heat insulation, and scald proof being achieved. Further, with reference to FIGS. 3-A˜C, the pattern model may also be applied on the surface layer for the spraying gun and or the rotary printing press to coat the coating on a portion of compound coating 4 that is provided with the pattern, as shown in FIGS. 1 and 2, and the layer heated by the heating device is foamed to form the 3D pattern 9; the protruding pattern provides the effect of heat insulation at the time of grip for achievement of the effects of artistic vision, heat preservation, heat insulation, and scald proof.

With reference to FIGS. 1, 2-A˜C, 3-A˜C, and 4-A˜C, the compound coating 4 may be coated in only the predetermined position and area of the container 7 (7′) that may be gripped. Alternatively, the compound coating 4 may be coated in the adequate recessed area 71 (71′) of the container when being formed. As shown in FIG. 4-C, and thus after being heated and foamed, the compound coating 4 is made to fill and level up the recessed position 71(71′), which makes the surface layer outside the container 7 (7′) recover the neat condition for the scald-proof effect brought to the position of grip, and for the cost-down request.

With reference to FIGS. 1, 3-A˜C, and 4-A and C, a color pigment 11 may be added to the compound coating 4 to form multicolored pattern in the foamed position, Alternatively, after the compound coating 4 is foamed and combined on the surface layer of the container 7 (7′), the color printing device 5″ may further be applied in a foamed position of the foamed layer 9, as shown in FIGS. 4-B and C, or in a position of the whole foamed layer that is formed with a colorful pattern, as shown in FIG. 4-A. A degree of thickness of the protruding position foamed with the pattern is achieved in a heating temperature of 100 through 140° C.

The embodiments of this invention are provided for reference only, comprising various paper-made or plastics-made container, such as the cup, the bowl, the dish, the lunch box, and various packaged container for the effects of heat insulation, heat preservation, and scald proof and for the enhanced effect.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A process of manufacturing thermal insulation and scald proof paper or plastic container comprising the following steps:
(1) Preparing a compound material by mixing and blending liquefied adhesive and a thermally foaming grains mixed and blended; and
(2) Coating the compound material on area specified on a continuously running paper web or a plastic material or on an area specified on a surface of the paper or plastic container; the coated continuously running paper web, plastic material or already molded container being put into a heating process; and the continuously running paper web or plastics being molded into the container as designed in the existing technology.

2. The process of manufacturing thermal insulation and scald proof paper or plastic container according to claim 1, wherein the liquefied adhesive is related to a mixture prepared by having water-base polyvinyl acetate epoxy, or polyethylene-polyvinyl acetate epoxy, or both of the polyvinyl acetate epoxy and the polyethylene-polyvinyl acetate epoxy mixed at any ratio.

3. The process of manufacturing thermal insulation and scald proof paper or plastic container according to claim 1, wherein the thermally foaming grains are related to low boiling point solvents wrapped up by thermoplastic polymers.

4. The process of manufacturing thermal insulation and scald proof paper or plastic container according to claim 1, wherein both of the liquefied adhesive and the thermally foaming grains are mixed at a ratio of 5-20;
80-95 by weight.

5. The process of manufacturing thermal insulation and scald proof paper or plastic container according to claim 1, wherein the coating is done before having adding color pigment into the compound coating in step (2).

6. The process of manufacturing thermal insulation and scald proof paper or plastic container according to claim 1, wherein before processing step (2), the area on an outer layer of the container specified for coating recessed towards an inner side of the container; and then the coating is applied where recessed for the compound coating when thermally heated fills the recessed area for the outer layer of the container to restore to its flushed condition.

7. The process of manufacturing thermal insulation and scald proof paper or plastic container according to claim 1, wherein the heating temperature in step (2) falls within a range of 100˜140□.

8. The thermal insulation and scald proof paper or plastic container manufactured using any process as claimed in one of claims 1 through 7.
